(19) United States
(12) Patent Application Publication
(10) Pub. No.: US 2005/0116572 A1
(43) Pub. Date: Jun. 2, 2005

(54) Rotating electrical unit and method of producing the same

(76) Inventors: Hiroshi Fukasaku, Aichi-ken (JP); Kiyoshi Uetsuji, Aichi-ken (JP); Ko Kajita, Gifu-ken (JP)

Correspondence Address: Morgan & Finnegan, L.L.P., 3 World Financial Center, New York, NY, 10281-2101, US

(21) Appl. No.: 10/968,636

(22) Filed: Oct. 19, 2004

(30) Foreign Application Priority Data
Oct. 20, 2003 (JP) 2003-359571

(51) Int. Cl. H02K 3/00; H02K 21/00; H02K 19/00; H02K 23/26

(52) U.S. Cl. 310/207; 29/596; 29/606; 310/180; 310/218

(57) ABSTRACT

A coil is formed by winding a flat conductor wire around a coil pre-forming tool in a predefined number of turns. The cross-section shape of the coil is made approximately the same as that of the slot in a stator core into which the coil is to be inserted. A stator of a rotating electrical unit is comprised by inserting the coil into a plurality of slots so as to cross over the plurality of slots.

### BACKGROUND OF THE INVENTION

1. Field of the Invention

The present invention relates to a rotating electrical unit and method of its production, particularly to a production method of the rotating electrical unit having a process for installing a coil preformed into a designed shape in a stator core.

2. Description of the Related Art

A rotating electrical unit has been conventionally and widely used in various fields. Here, the rotating electrical unit, including a motor and a generator, is used, as example and not limited to, as a drive motor for the compressor of an air conditioner, a drive motor for an electric automobile including a hybrid automobile and the generator for an automobile.

The rotating electrical unit is generally provided with a coil for generating a magnetic field (while in a generator, a coil for generating electromotive force in accordance with the change of flux). A simplified production process for the coil will gain a various benefits such as a production cost reduction of the rotating electrical unit. Hence, those methods described in the patent documents 1 through 4 listed below are known as techniques for simplifying the production process of a coil for the rotating electrical unit.

In the production method described in the patent documents 1 and 2, first, a conductor wire is wound in a ring for a plurality of turns as shown in FIG. 1A, then, the ringed-coil is formed into a cyclical concavity-convexity form corresponding to the number of poles in a motor, as shown in FIG. 1B. Then the conductor wire is inserted into the slots provided in the stator core of a motor. As such, in the production methods described in these patent documents, coils preformed into a designed shape in advance are prepared for inserting in to the slots of a stator core. This method renders higher process efficiency as compared to a method of directly winding a conductor wire in the slots of a stator core.

Also in the patent document 3, a production method in which a coil preformed into a designed shape is prepared for inserting into the slots of a stator core. However, in the production method described in the patent document 3, the pole-specific coils are preformed for each of individual poles and those coils are inserted into each one set of the corresponding slots. Alternatively, in the production method described in the patent document 4, a plurality of pine needle shaped conductors, called segment coils, are inserted into a set of corresponding slots, and a coil is formed by connecting those conductors one after another. Also known as other related techniques are given in the patent documents 5 and 6.

[Patent Document 1]

Japanese patent laid-open application publication 2002-209358 (FIGS. 6 and 7, paragraphs 0013 through 0015)

[Patent Document 2]

Japanese patent laid-open application publication 10-14149 (FIGS. 1 and 2, paragraphs 0007 through 0010)

[Patent Document 3]

Japanese patent laid-open application publication 2003-153478 (FIG. 4, paragraphs 0012 through 0014)

[Patent Document 4]

Japanese patent laid-open application publication 2001-37132 (FIGS. 2 through 6)

[Patent Document 5]

Japanese patent laid-open application publication 10-271733

[Patent Document 6]

Japanese patent laid-open application publication 2000-69700

Incidentally, a rotating electrical unit is required not only to be produced in a simple process as described above, but also have a high efficiency thereof. Note that the efficiency of a rotating electrical unit increases as the conductor wires constituting a coil is wound more closely. That is, the efficiency of a rotating electrical unit increases with the lamination factor of the conductor wires in a slot housing the coil. Here, the lamination factor of the conductor wires in a slot is defined as a ratio of “the sum of each cross-sectional area of a plurality of the conductor wires housed in the slot” to “the cross-sectional area of the slot.”

Whereas those conventional rotating electrical units produced by the processes such as the above mentioned process, in which the coils preformed into a designed shape is inserted into the slot of a stator core, have not necessarily achieved high lamination factor in the respective slots. In other words, it has conventionally been difficult to obtain a simplification of the production process while increasing the efficiency of a rotating electrical unit by improving the lamination factor of the conductor wires in a slot.

Meanwhile, in the motor noted in the patent document 3, there are problems such as: (1) being unable to form coils in three or more slots continuously; (2) ending up with a large coil end for insertion due to the coil end being stacked together in one side of the core; (3) requiring a special tool for forming coils into a particular shape and an apparatus for installing the coil in a stator; and (4) being limited to adopt it for a stator having semi-closed slots.

On the other hand, in the motor noted in the patent document 4, since the plurality of the segment coils have to be welded together one after another for forming a coil, the production process becomes complicated in addition to a reduced efficiency of the motor itself due to a loss in the welded points. Additionally, the number of the coil turns and slots need to be increased for a usage under high voltages, thereby reducing the productivity and the efficiency of the motor itself. Furthermore, it is difficult to increase the number of the coil turns, turn by turn, due to its coil layout, hence there is a limited freedom in designing a product.

### SUMMARY OF THE INVENTION

The objective of the present invention is to provide a rotating electrical unit having a simple production process and a high efficiency, and its production method.

A production method of a rotating electrical unit according to the present invention includes the first process forming a coil by winding a flat conductor wire in a plurality of turns around a pre-forming member having a designed shape, and the second process producing a stator by inserting the coil into three or more slots provided in a stator core of a rotating electrical unit so as to cross over the plurality of slots, wherein, in the first process, the flat conductor wire is wound around the pre-forming member so that a cross-section shape of the coil is matched approximately with that of the slot.

According to the invention, since the coil pre-formed to a designed shape is inserted into three or more slots so as to cross over the plurality of slots, the production process is simple. And since the flat conductor wire is used as a conductor wire for constituting the coil, the lamination factor (or density) of the conductor wires in a slot is increased, thereby improving the efficiency of a rotating electrical unit. Moreover, since the cross-section shape of the coil is matched approximately with that of the slot, the lamination factor of the conductor wires in a slot is further increased, thereby improving the efficiency of the rotating electrical unit as that much.

In the second process of the above described production process, the coil may be inserted into three or more slots so as to cross over the plurality of slots and form wave winding. According to the invention, a fewer number of process is required, and a smaller loss in the coil itself is performed as compared to the production process in which a plurality of segment coils are inserted into the corresponding slots and then connected with each other.

And in the production method described above, the first process may include the first sub-process for winding n-turns of said flat conductor wire so that the flat conductor wire is wound sequentially in n-columns lined up in the first direction while being pressed against a pressure surface of the pre-forming tool, the second sub-process for winding n-turns of the flat conductor wire so that the flat conductor wire is wound sequentially in n-columns lined up in the direction opposite to the first direction stacking outward on the flat conductor wire wound in the first sub-process, and the third sub-process for alternating the first sub-process and the second sub-process so that the flat conductor wire is wound further stacking outward on the flat conductor wire wound in the first and second sub-processes. Furthermore, the flat conductor wire may be further wound following the third sub-process so as to make the cross-section shape of the coil a trapezoid. According to these inventions, the flat conductor wire constituting the coil is always adjacent to the one previously wound, making the alignment of wires constituting a coil minimally disturbed, resulting in higher lamination factor of the conductor wires in a slot and improving the efficiency of a rotating electrical unit.

Furthermore, in the production method as described above, a plurality of operations for winding the flat conductor wire in a plurality of turns may be performed in the first process so as to stack in the direction vertical to a surface of the pre-forming member. According to the invention, since there is less number of times in which the alignment of conductor wires constituting a coil is disturbed, the lamination factor of the conductor wires in a slot is higher as that much. Note that, if the number of turns wound in the plurality of operations above is made the same for each winding operation, the cross-section shape of the coil becomes a rectangle, while if the number of turns wound in the plurality of operations above is sequentially incremented one by one, the cross-section shape of the coil becomes a trapezoid.

Furthermore in the production method as described above, the surface of a pre-forming member is featured stepwise, and the flat conductor wire is wound in the first process so that the number of turns of the flat conductor wire being stacked in the direction vertical to each step of the surface of the pre-forming member may increment by a predefined number for respective step. According to the invention, the cross-section shape of the coil becomes a trapezoid.

Furthermore in the production method as described above, the pre-forming member comprises a straight area and a curved area, and the coil comprises a plurality of straight portions formed by using the straight area of the pre-forming member, and a curved portion formed by using the curved area of the pre-forming member. Each of the plurality of straight portions of the coil is inserted into the corresponding slot, and the curved portion of the coil is allocated so that the curved portion of the coil crosses over the slots each inserted with the straight portion of the coil in the second process. And if the flat conductor wires are not allowed to cross with each other in the straight portion of the coil in the first process, the alignment of the conductor wires in a slot is secured. And if the stator core is disposed for installing a plurality of coils produced in the first process, each curved portion may be respectively formed prior to the second process so that coils do not interfere with one another when each of the plurality of coils is installed in the stator core. This makes the operation for inserting the coils into corresponding slots easy.

Furthermore in the production method as described above, after the coil is treated with an insulation processing, the insulated coil is inserted into the slots in the second process. According to the invention, there is no need to pre-install an insulation sheet in the slot. And with the pre-treatment of an insulation processing for the coil, the alignment of the flat conductor wires is hard to disturb when inserting the coil into the corresponding slots.

A rotating electrical unit according to the invention comprises a stator having a stator core installed with the coils, wherein the coil consists of the flat conductor wires, the cross-section shape of the coil is configured matching approximately with that of slots provided in the stator core. The stator is produced by inserting the coil into three or more slots provided in the stator core so as to cross over the plurality of slots.

In the invention, since a coil is formed to a designed shape by using the flat conductor wire and a stator is produced by inserting the coil in the corresponding slots in the stator core of a rotating electrical unit, it is possible to provide the rotating electrical unit by a simple production process and with a high efficiency thereof. In accordance with this, it is also possible to make a rotating electrical unit compact.

### BRIEF DESCRIPTION OF THE DRAWINGS

FIGS. 1A and 1B illustrate an example of prior art;

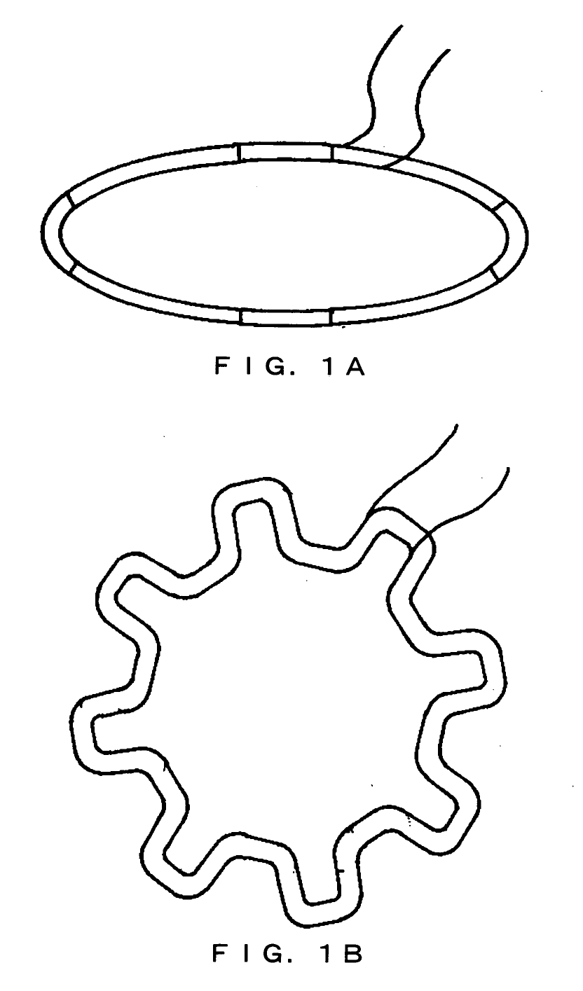

FIG. 2 shows an oblique perspective figure of an embodiment of a stator core constituting a rotating electrical unit according to the present invention;

FIG. 3 shows a top view of the stator core shown in FIG. 2;

FIG. 4 illustrates a coil pre-forming tool for forming a coil;

FIG. 5 shows an example of a coil produced by using a coil pre-forming tool;

FIG. 6 illustrates a coil formed for installing in a stator core;

FIGS. 7A through 7C show a state in which coils are inserted into a stator core;

FIGS. 8A and 8B illustrate a comparison in the lamination factor between a round and flat conductor wires;

FIGS. 9A and 9B show the winding order of a flat conductor wire according to the embodiment 1;

FIG. 10 describes a winding method of a flat conductor wire;

FIGS. 11A and 11B show the winding order of a flat conductor wire according to the embodiment 2;

FIGS. 12A and 12B show the winding order of a flat conductor wire according to the embodiment 3;

FIGS. 13A and 13B show the winding order of a flat conductor wire according to the embodiment 4;

FIGS. 14A through 14C describe an insertion process for coils into the slots corresponding to a stator core;

FIG. 15 illustrates another embodiment of the cross-over portions of coils;

FIG. 16 shows another embodiment of a stator core; and

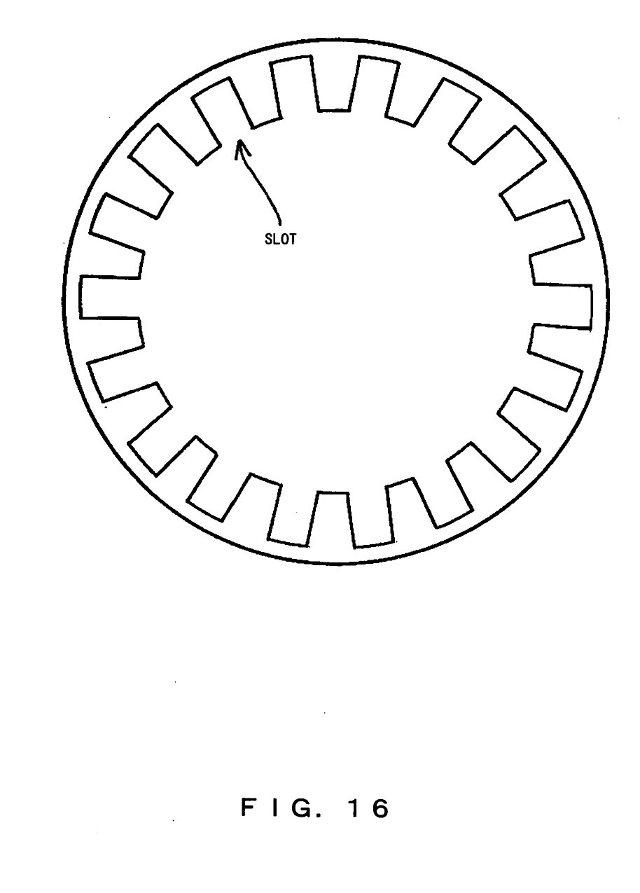

FIGS. 17A and 17B illustrate other examples of formed coils.

### DESCRIPTION OF THE PREFERRED EMBODIMENTS

A rotating electrical unit according to the present invention includes a stator and a rotor as a common rotating electrical unit and the invention has no specific characteristics in the rotor structure. Accordingly a description of the rotor is omitted herein. Also, in the production method of the rotating electrical unit according to the present invention, the premise is that the production processes except for that of a stator can be accomplished by the conventional techniques. Note that the following specification is described by choosing a 3-phase rotating electrical unit having 6 poles in each phase as a case for description.

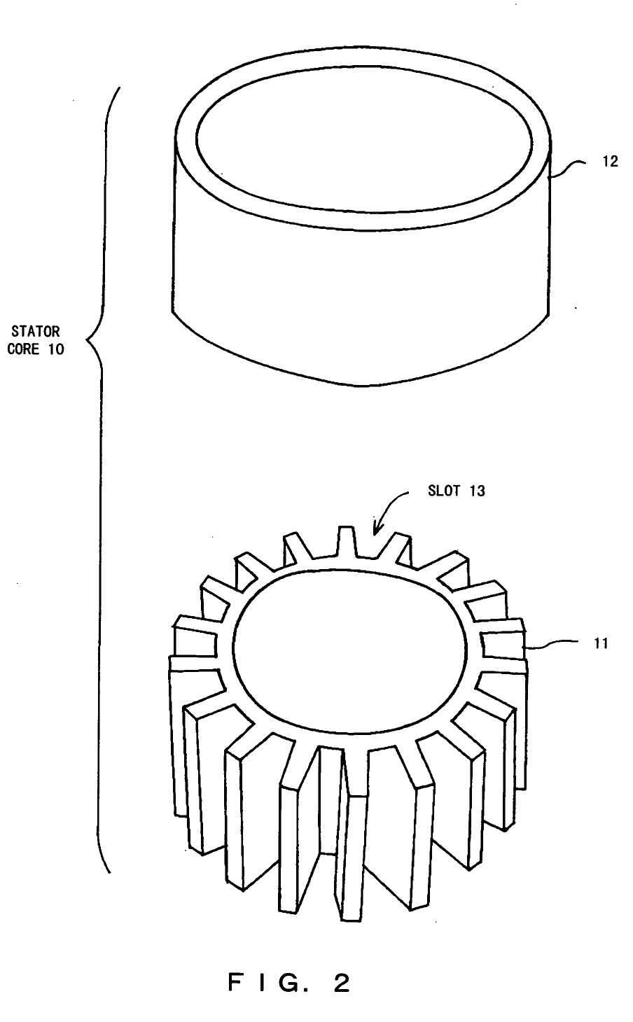

FIG. 2 shows an oblique perspective figure of an embodiment of a stator core 10, in the disassembled state, constituting a rotating electrical unit according to the present invention. The stator core 10 consists of an inner ring member 11 and an outer ring member 12 as shown in FIG. 2. Note that the inner ring member 11 is provided with a plurality of protrusions which protrudes in the diametrical direction thereof. And each of slots 13 is provided between each of the protrusions. Also note that these slots are used for housing coils as described later in detail. On the other hand, the outer ring member 12, being in the shape of an approximate cylinder, is disposed for enclosing the inner ring member 11. Note that an inner ring member 11 may optionally be configured as having slot openings on the inner diameter thereof, although the shown example is otherwise configured.

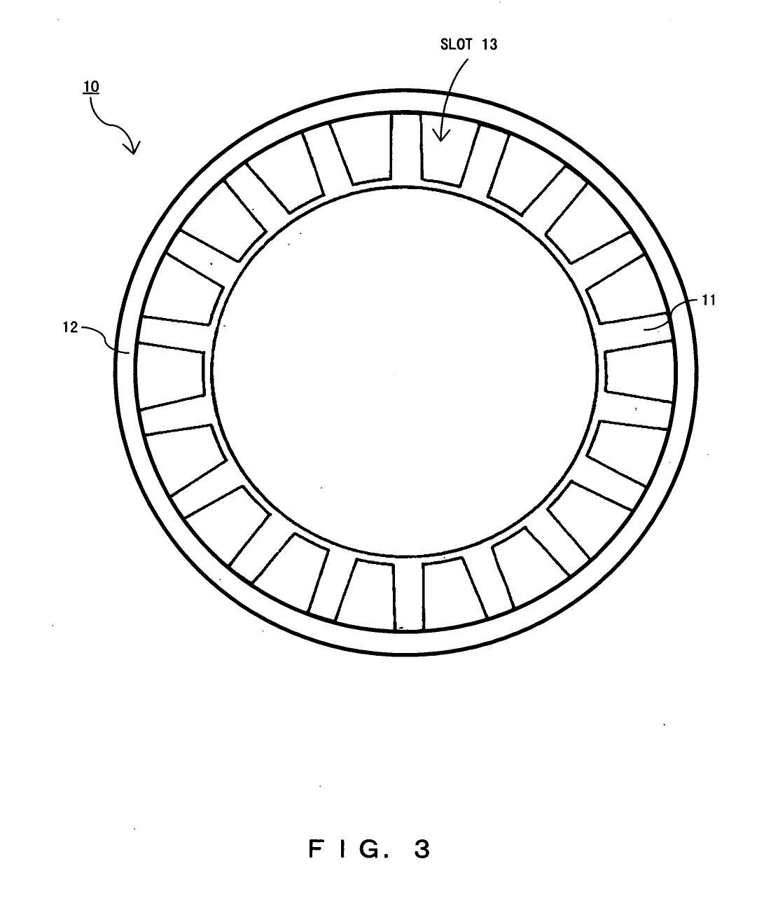

FIG. 3 shows a top view of the stator core 10 in which the outer ring member 12 is installed on the outside of the inner ring member 11. As shown, the stator core 10 is provided with a plurality of the slots 13 (18 slots in this example). And the cross-section shape of each slot 13 is “a trapezoid (or a fan shape)”.

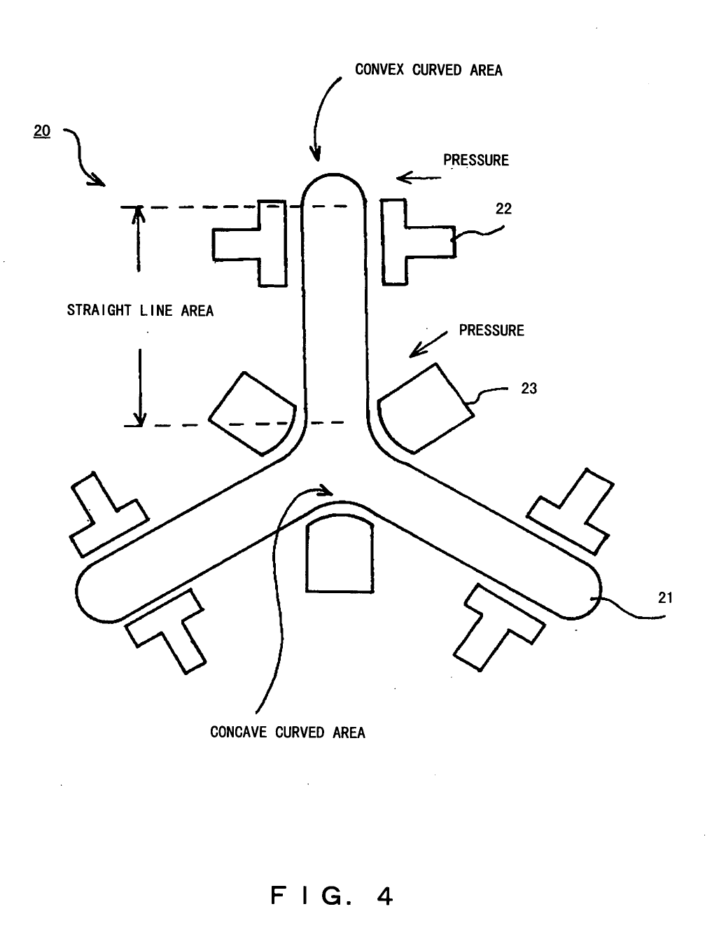

FIG. 4 illustrates a coil pre-forming tool 20 for forming a coil. Note that the coil pre-forming tool 20 is capable of forming a coil for one phase (e.g., U-phase, V-phase or W-phase) in one process. And the coil pre-forming tool 20 is configured considering the case where six poles for each phase.

The coil pre-forming tool 20 comprises a main body (i.e., a forming member) 21, a straight-portion pressure member 22 and a curved-portion pressure member 23. The main body 21 comprises the straight portions protruding in three radial directions, the convex curved portions featured at the end of each straight portion, and the concave curved portions provided nearby the base of the straight portions. The straight-portion pressure member 22, being set aside of the straight portion of the main body 21, is disposed for pressing the conductor wires wound around the main body 21 against the corresponding straight portion. Meanwhile, the curved-portion pressure member 23, being set aside of the concave curved portion of the main body 21, is disposed for pressing the conductor wires wound around the main body 21 against the corresponding concave curved portion.

By winding a conductor wire around the main body 21 in a plurality of turns, a coil to be installed in the stator core 10 is formed, which is called the first process. In this process, the conductor wire, having been wound around the main body 21 in such a way that it passes between the main body 21 and the straight portion pressure member 22 and between the main body 21 and the curved-portion pressure member 23, are formed into the same shape as the outer contour shape of the main body 21. Note that a conductor wire used in the present embodiment is a “flat conductor wire,” whose cross-section shape is either a rectangle or an approximate rectangle, which will be described in detail later.

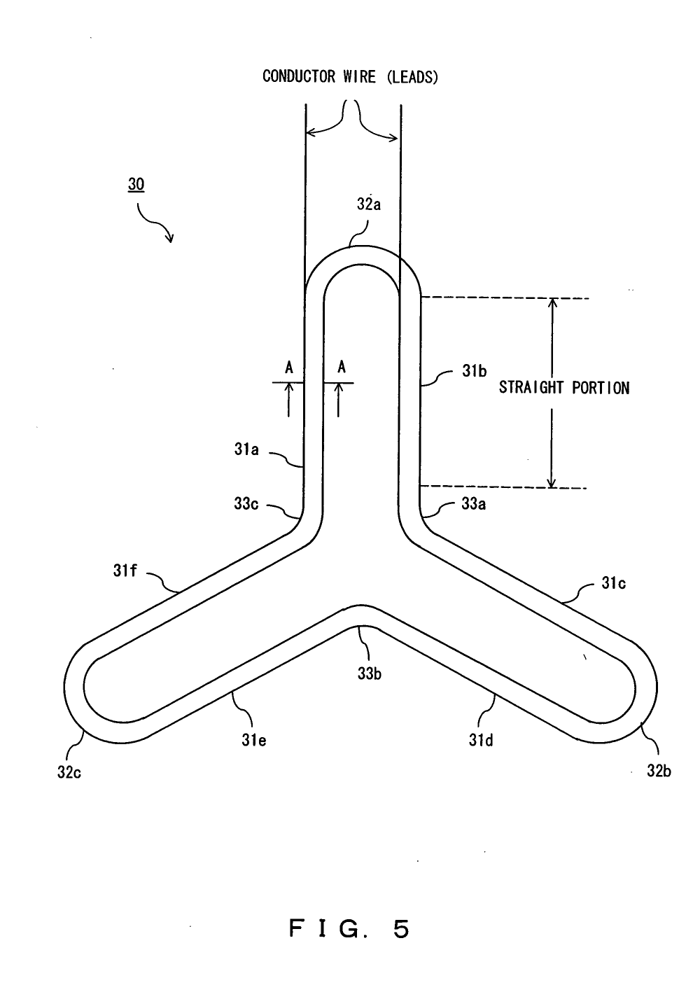

FIG. 5 shows an example of a coil 30 produced by using a coil pre-forming tool 20. Note that the coil 30 is formed by winding the conductor wire around the main body 21, as described above, in a plurality of turns, e.g., between a few turns and tens of turns. Therefore, the coil 30 comprises the straight portions formed utilizing the straight portions of the main body 21, the convex curved portions formed utilizing the convex-curved portions of the main body 21 and the concave curved portions utilizing the concave-curved portions of the main body 21. Specifically, the coil 30 consists of the straight portions 31a through 31f, the convex curved portions 32a through 32c and the concave curved portions 33a through 33c. Note that the convex curved portions 32a through 32c and the concave curved portions 33a through 33c are sometimes called simply “curved portions or curved portions of a coil.”

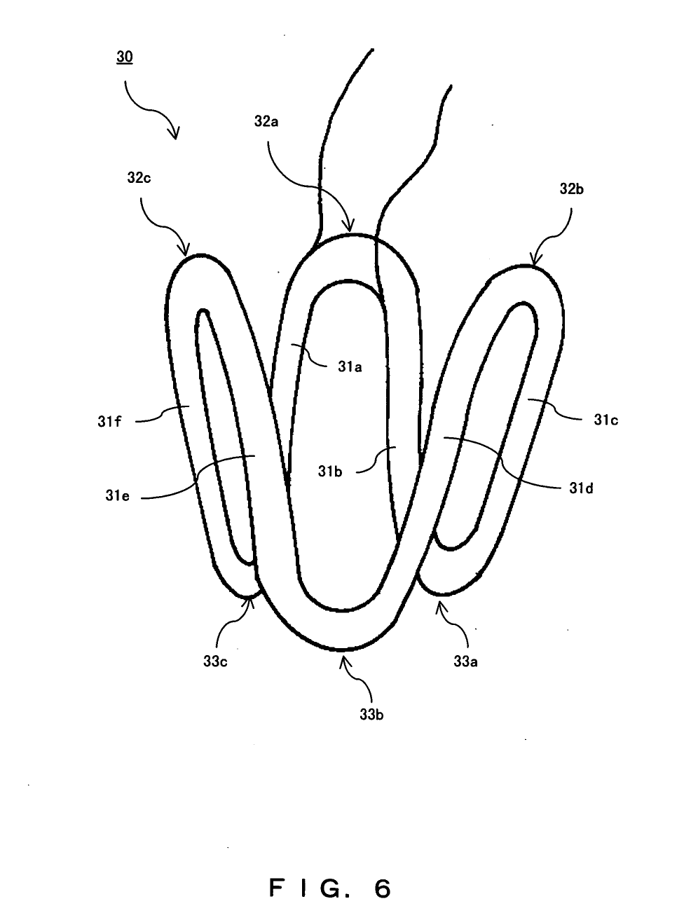

Then the coil 30 thus preformed is further formed into as shown in FIG. 6. That is, the coil 30 is formed in such a way that each of the straight portions 31a through 31f is bent upwards at around the respective concave curved portions 33a through 33c. In other words, the coil 30 is formed so that each of the straight portions 31a through 31f is inserted into the corresponding slot provided in the inner ring member 11 of the stator core 10. Note that, in this process, each of the straight portions 31a through 31f of the coil 30 is maintained substantially straight.

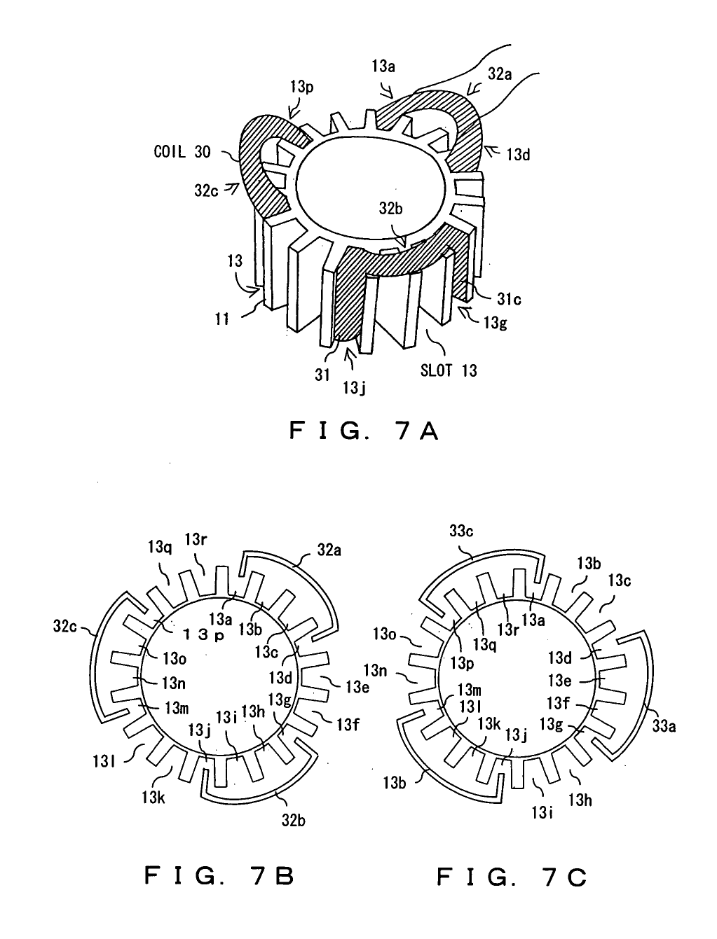

FIGS. 7A through 7C show a state in which a coil is inserted into the corresponding slots of a stator core. FIG. 7A, FIG. 7B and FIG. 7C show, respectively, an oblique perspective figure, an illustration of the convex curved portions of the coil allocated on the upper side of the stator core, and an illustration of the concave curved portions of the coil located on the bottom side of a stator core. Note that, here, the outer ring member 12 is omitted, and the coils for one phase only are shown, for an easy viewing of the drawings.

The coil 30 formed into the shape as shown in FIG. 6 is then installed so as to enclose the inner ring member 11 of the stator core 10 from the outside thereof. In this process, each of the straight portions of the coil 30 is inserted into the corresponding every third of the slots, which is called the second process. Specifically, the straight portions 31a, 31b, 31c, 31d, 31e and 31f of the coil 30 are inserted into the slots 13a, 13d, 13g, 13j, 13m and 13p, respectively, out of the 18 slots 13a through 13r.

The convex curved portions 32a through 32c of the coil 30, as shown in FIGS. 7A and 7B, are allocated so as to cross over between the slots which the respective straight portions thereof are inserted into. In this example, the convex curved portion 32a is allocated so as to cross over from the top end of the slot 13a to that of the slot 13d, the convex curved portion 32b is allocated so as to cross over from the top end of the slot 13g to that of the slot 13j, and the convex curved portion 32c is allocated so as to cross over from the top end of the slot 13m to that of the slot 13p. In the meantime, the concave curved portions 33a through 33c of the coil 30, as shown in FIG. 7C, are allocated so as to cross over between the slots which the straight portions of the coil 30 are inserted into. In this example, the concave curved portion 33a is allocated so as to cross over from the bottom end of the slot 13d to that of the slot 13g, the concave curved portion 33b is allocated so as to cross over from the bottom end of the slot 13j to that of the slot 13m, and the concave curved portion 33c is allocated so as to cross over from the bottom end of the slot 13p to that of the slot 13a. Note that the convex curved portions 32a through 32c and the concave curved portions 33a through 33c cross over between the inserted slots when the coil 30 is installed in the stator core 10 as described above, and hence these portions are sometimes called a “cross-over portion (or cross-over portion of a coil).”

Then, after the coil 30 is installed in the inner ring member 11, the outer ring member 12 is installed so as to enclose the inner ring member 11, thereby the stator for a rotating electrical unit being comprised.

As a result, a stator is completed comprising distributed wave winding in which the coil is inserted into three or more slots (six slots in the present embodiment) with each coil crossing over a plurality of slots. Here, for example, the coil winding is done in the following route: the upper end of slot 13d→lower end of slot 13d→lower end of slot 13g→upper end of slot 13g→upper end of slot 13j→lower end of slot 13j→lower end of slot 13m→upper end of slot 13m→upper end of slot 13p→lower end of slot 13p→lower end of slot 13a→upper end of slot 13a→upper end of slot 13d and so on.

The coil 30 may be treated with an insulation processing before the coil 30 is inserted into the slots of the stator core 10. The insulation processing thereof may be, for example, applied to the straight portion (or both the straight and curved portions) of the coil 30 by covering with insulation paper, insulation film or plastic materials. With such processing, the insulation between the coil 30 and the stator core 10 is secured by merely inserting the insulation-processed coil 30 into the corresponding slots, eliminating a need to insert an insulation paper or the like into each slot of the stator core 10 beforehand. Also, an insulation processing for the coil 30 as above described at the time when it is configured as shown in the FIG. 5 makes the alignment of the conductor wires constituting the coil 30 hard to disturb when forming it into the shape as shown in FIG. 6. Furthermore, an insulation processing as above described for the coil 30 at the time when it is configured as shown in the FIG. 6 makes the alignment of the conductor wires constituting the coil 30 hard to disturb when inserting it into the corresponding slots of the stator core 10.

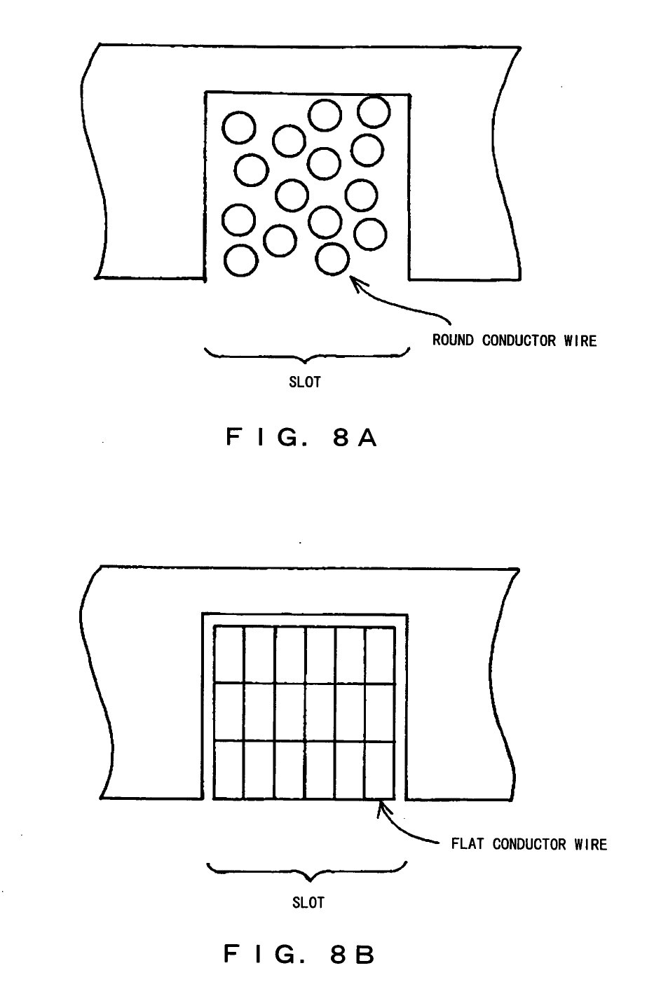

For a conductor wire constituting a coil, a “round conductor wire” whose cross-section shape being a circle is generally used. In particular, the round conductor wire is basically used for producing a rotating electrical unit in the production process in which coil preformed into a designed shape is inserted into the slots of the stator core in consideration of an ease of the coil forming. However, forming a coil by using the round conductor wire causes the inevitable gaps among the wires, as shown in FIG. 8A, even though the wires are well aligned together, hence resulting in a reduced lamination factor of the conductor wires in a slot.

On the other hand, in the rotating electrical unit according to the present embodiments of the invention, a “flat conductor wire” whose cross-section shape being a rectangle or approximate rectangle is used for a conductor wire constituting a coil. Here, configuring a coil by the flat conductor wire makes it possible to align the conductor wires without causing gaps in the slot as shown in FIG. 8B, which accordingly increases the lamination factors of the conductor wires in a slot. That is, the cross-sectional area of the conductor wire is larger with the flat conductor wires, given that the number of the conductor wires is the same between the round and flat conductor wires. Therefore, the efficiency of the rotating electrical unit is improved by constituting the coil with the flat conductor wire.

Meanwhile, in the production method according to the present embodiments of the invention as described referring to FIGS. 4 through 7C, the coil 30 preformed into the designated shape is inserted into the slots 13. Here, the coil 30 is formed in such a way that the cross-section shape thereof is matched approximately with that of the slot 13. For instance, if the cross-section shape of the slot 13 is a “trapezoid (refer to FIG. 3)” the coil 30 is formed so that its cross-section shape is a “trapezoid.” Alternatively, if the cross-section shape of the slot 13 is a “rectangle,” then the coil 30 is formed so that the cross-section shape thereof being a “rectangle”. Accordingly, the lamination factor of the conductor wires in a slot is improved further, thus increasing the efficiency of a rotating electrical unit as that much.

Note that, in the case of using round conductor wire for constituting a coil, aligning the round wires is difficult when forming them into a particular shape as compared to the flat rectangular wires, which makes it difficult to pre-form the coil with a round wire so that the cross-section shape of the coil is matched with that of the slot.

The preferred embodiments of producing the coil 30 will then be described. The coil 30 is, as shown in FIG. 5, assumed to consists of the straight portions 31 (31a through 31f), the convex curved portions 32 (32a through 32c) and the concave curved portions 33 (33a through 33c).

The coil 30 is pre-formed by winding the flat conductor wire around the main body 21 of the coil pre-forming tool 20 for a plurality of turns while aligning the flat conductor wire. Then the coil 30 pre-formed as such is formed as shown in FIG. 6 enables to be inserted into the corresponding slots of the stator core 10. Whereas, in the forming process and/or the subsequent insertion process, it is possible to disturb the alignment of the flat conductor wires constituting the coil 30. Therefore, in the production method according to the embodiments, contrivances are presented for winding the flat conductor wire around the main body 21 of the coil pre-forming tool 20 so as to minimize a disturbance of the alignment of the flat conductor wires when forming the coil 30.

### Embodiment 1

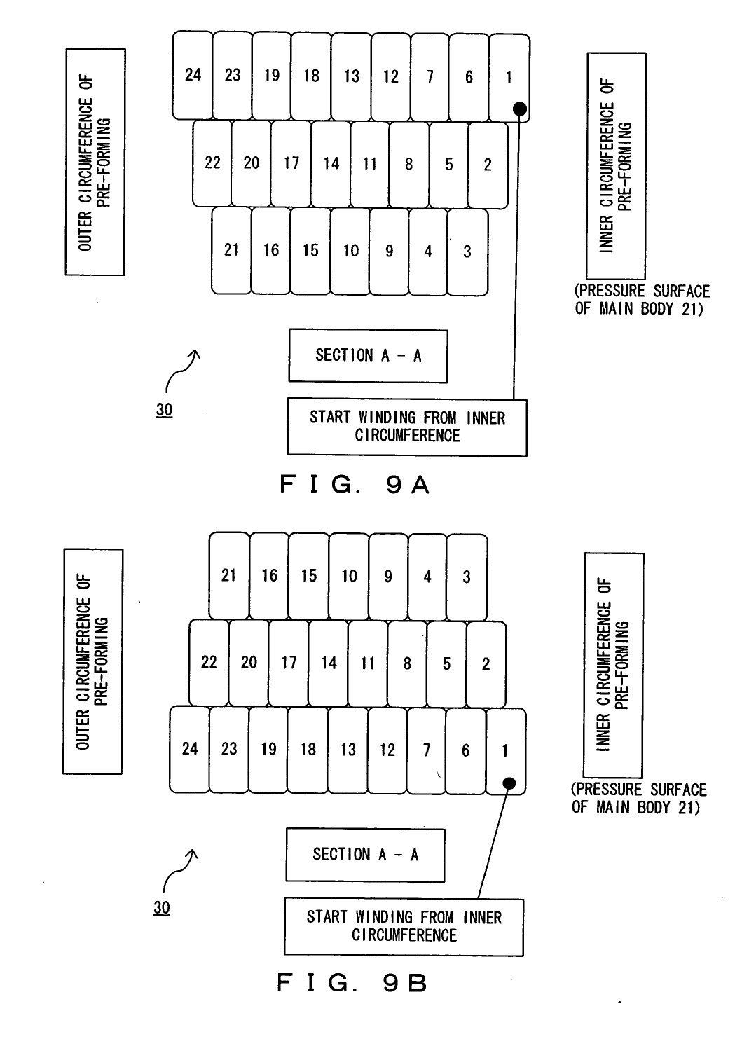

FIGS. 9A and 9B show the winding order of a flat conductor wire according to the embodiment 1, and the section A-A of the coil 30 shown in FIG. 5. Note that the cross-section shape of the slot 13 is a “trapezoid (refer to FIG. 3)” in the embodiment 1.

In the embodiment 1, first, the flat conductor wire is wound in three turns around while lining up the wire side by side along the main body 21 of the coil pre-forming tool 20 (called the first sub-process). Note here that “the first direction” specified in the claim, in FIG. 9A for example, is defined as the direction traveling from the position where the conductor wire numbered “1” is located to the position where the conductor wire numbered “3” is located. Then the flat conductor wire is wound in the fourth through sixth turns (called the second sub-process) so as to stack outward on the flat conductor wire wound in the first process, in which the flat conductor wire is lined up in a reverse order with the first sub-process. That is to say, the flat conductor wire in the fourth turn is stacked outside of the third turn thereof, the flat conductor wire in the fifth turn outside the second turn thereof, and the flat conductor wire in the sixth turn outside the first turn thereof.

And likewise, the first and second sub-processes are alternately performed so as to wind the flat conductor wire further on the outside of previously stacked wires (called the third sub-process). In such a way, the flat conductor wire is wound in the seventh through the 21st turns.

Subsequently, in order to make the cross-section shape of the coil 30 a “trapezoid,” the 22nd turn of the flat conductor wire is stacked on the 20th turn thereof, the 23rd turn of the flat conductor wire on the 19th turn thereof, and 24th turn of the flat conductor wire on the 23rd turn thereof. As a result, as shown in FIG. 9A or FIG. 9B, the number of turns of the flat conductor wire stacked on each of the three columns of the flat conductor wire becomes sequentially different by one. That is, the cross-section shape of the coil 30 becomes a “trapezoid.”

Note that the cross-section shape of the coil 30 can be changed by the cross-section shape of the flat conductor wire, the number of turns of winding the flat conductor wire around the coil pre-forming tool 20, the number of columns and rows, i.e., in the vertical and horizontal directions on the paper as seen in FIGS. 9A and 9B, in which the flat conductor wires are lined up, etc. In other words, the cross-section shape of the coil 30 can be approximately matched with that of the slot 13.

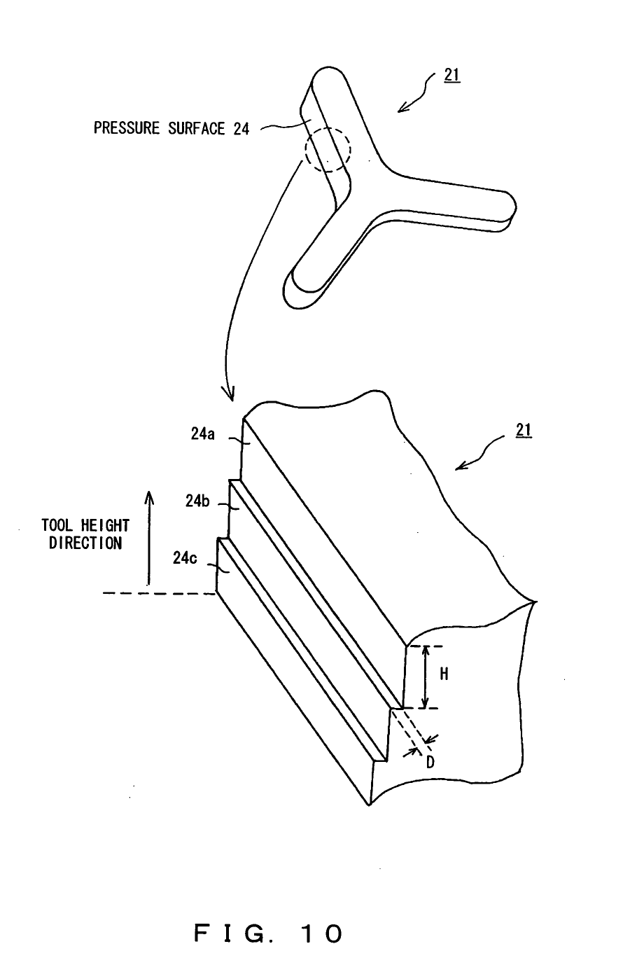

FIG. 10 describes a winding method of a flat conductor wire. The coil 30 is formed by winding the flat conductor wire while being pressed onto the pressure surface 24 on the main body 21 of the coil pre-forming tool 20. Here, the pressure surface 24 may be configured stepwise for example as shown in FIG. 10 in order to make the cross-section shape of the coil 30 a “trapezoid.” In this case the pressure surface 24 is featured by pressure surfaces 24a through 24c. The height H of each step is for example the same as the width of the flat conductor wire, while the depth D of these steps is for example approximately half the thickness of the flat conductor wire.

Now, for example, in the case of forming a coil as shown in FIG. 9A, while maintaining the height of the flat conductor wire at the height of the pressure surface 24a, the flat conductor wire is wound around the main body 21 in one turn while pressing it on the pressure surface 24a. Then, while maintaining the height of the flat conductor wire at the height of the pressure surface 24b, and the flat conductor wire is wound around the main body 21 in one turn while pressing it on the pressure surface 24b. Furthermore, after adjusting the height of the flat conductor wire at that of the pressure surface 24c, the flat conductor wire is wound around the main body 12 in one turn while pressing it on the pressure surface 24c. Likewise, while maintaining the flat conductor wire at the different heights sequentially, the flat conductor wire is wound around the main body 21 repeatedly.

Incidentally, in general, configuring a coil by winding a conductor wire in a plurality of turns, the wires sometimes cross with one another in a space of the coil where a disturbance in the alignment of the conductor wires will result.

If crossing between the flat conductor wires is inevitable while winding the wire around the main body 21 of the coil pre-forming tool 20, a care must be taken to have the wires cross in a curved portion (for example, a convex curved portion) of the main body 21, in order to avoid crossing the flat conductor wires at least at a straight portion of the main body 21, thereby maintaining the alignment of the flat conductor wires in the straight portions 31a through 31f of the coil 30. In other words, the flat conductor wires constituting the coil 30 maintain the alignment thereof at least within the slots of a stator core 10.

If the flat conductor wire is wound in the above described order, two wires cross with each other at the start of 4th, 7th, 10th, 13th, 15th, 18th, 21st and 24th turns, for example. That is, for instance, the flat conductor wire comes to cross at the beginning of the 4th turn, riding diagonally over the flat conductor wire laid at the 3rd turn thereof. Except that, if the flat conductor wire is wound in the order as shown in FIG. 9A or 9B, there is little disturbance in the alignment of the flat conductor wires since the flat conductor wires which would otherwise cross with each other, e.g., the flat conductor wires in the third and fourth turns, are adjacent to each other in the cross section of the coil 30.

### Embodiment 2

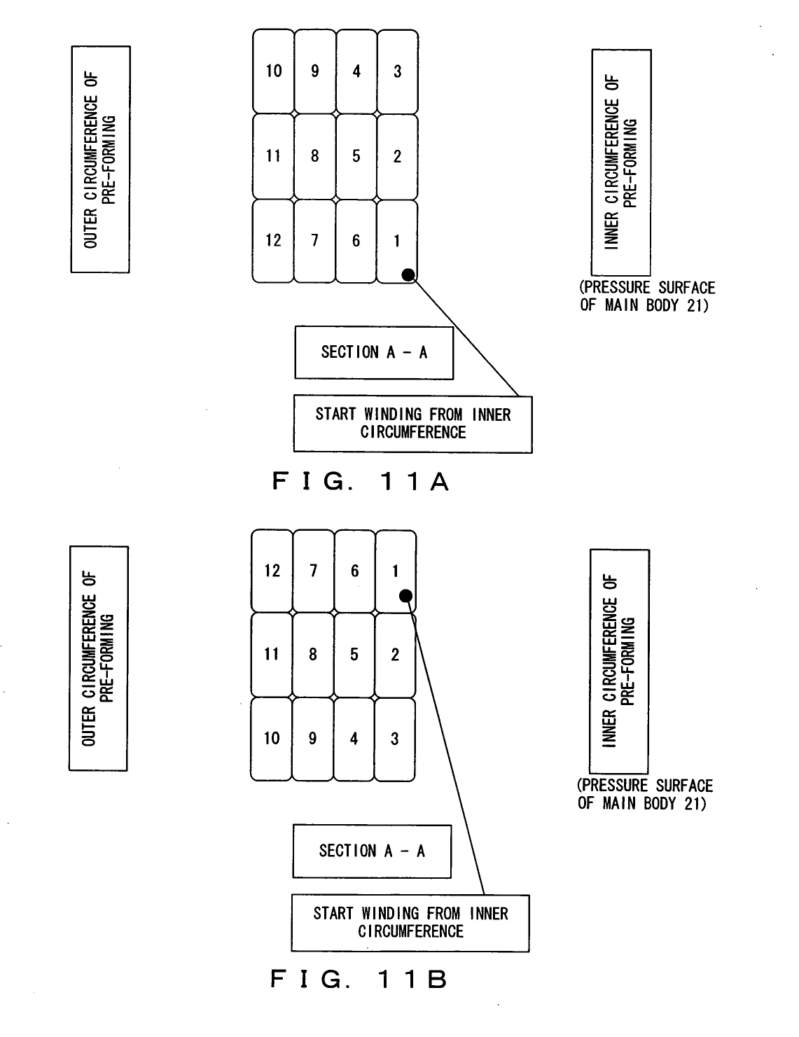

FIGS. 11A and 11B show the winding order of a flat conductor wire according to the embodiment 2. Note that while the cross-section shape of the slot of a coil stator core is assumed to be a “rectangle” in the embodiment 2, the basic process for winding the wire is the same as in the embodiment 1, hence omitted herein. However, the pressure surface 24 of the coil pre-forming tool 20 does not need to be featured stepwise in the embodiment 2. It shall be noted that the same overall benefit is gained in the embodiment 2 as in the embodiment 1.

### Embodiment 3

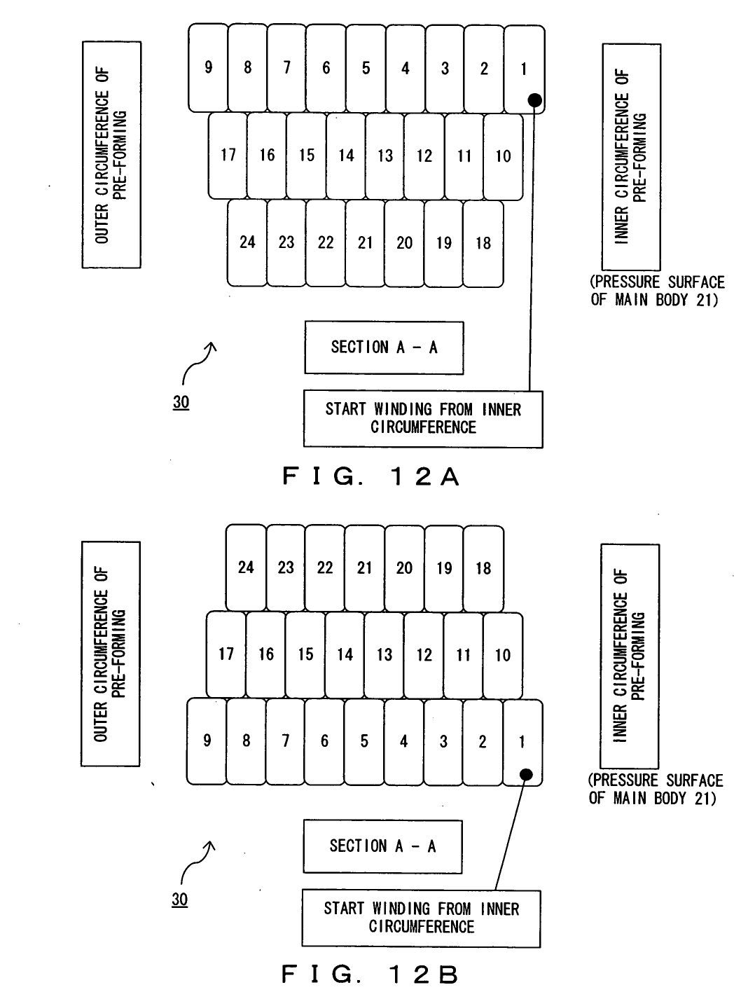

FIGS. 12A and 12B show the winding order of a flat conductor wire according to the embodiment 3. Note that the cross-section shape of the slot of a coil stator core is assumed to be a “trapezoid” in the embodiment 3 as in the embodiment 1.

In the embodiment 3, the process for winding the flat conductor wire in a predefined number of turns is done a plurality of times so as to stack vertically to the pressure surface 24 on the main body 21 of the coil pre-forming tool 20. In this instance, first, the flat conductor wire is wound so as to stack in the first through the ninth turns of winding the flat conductor wires in the direction of the outer circumference. Then, the 10th through 17th turns of the flat conductor wires are wound in adjacent to the stack of the flat conductor wires wound in the first through the ninth turns. The 18th through 24th turns of the flat conductor wires are further wound in adjacent to the 10th through 17th turns thereof.

Also in the embodiment 3, the same as in the embodiment 1, the pressure surface 24 of the coil pre-forming tool 20 is featured stepwise, as shown in FIG. 10. The flat conductor wire is wound so as to stack in a different column for each step. The number of winding turns stacking the flat conductor wires on the respective step changes one by one in accordance with the winding column order (in this example, nine turns, eight turns and seven turns), which will make the cross-section shape of the coil 30 a “trapezoid.”

Note that the number of winding turns stacking the flat conductor wires on the respective step can be changed to a predefined decrement, e.g., “2,” in which case the cross-section shape of a coil becomes also a “trapezoid.”

Also in the embodiment 3, in the example shown by FIG. 12A, first, the flat conductor wire is wound for nine turns while maintaining the height thereof at the height of the pressure surface 24a, followed by eight turns thereof while maintaining the height thereof at the height of the pressure surface 24b. Furthermore, seven turns of the flat conductor wire is wound while maintaining the height thereof at the height of the pressure surface 24c. That is, in the embodiment 3, the number of points where the flat conductor wire crosses over the flat conductor wire wound in the previous turn in the process for configuring the coil 30 is limited to a minimum. Therefore, the number of points where the alignment of the flat conductor wires constituting the coil 30 is disturbed is reduced.

### Embodiment 4

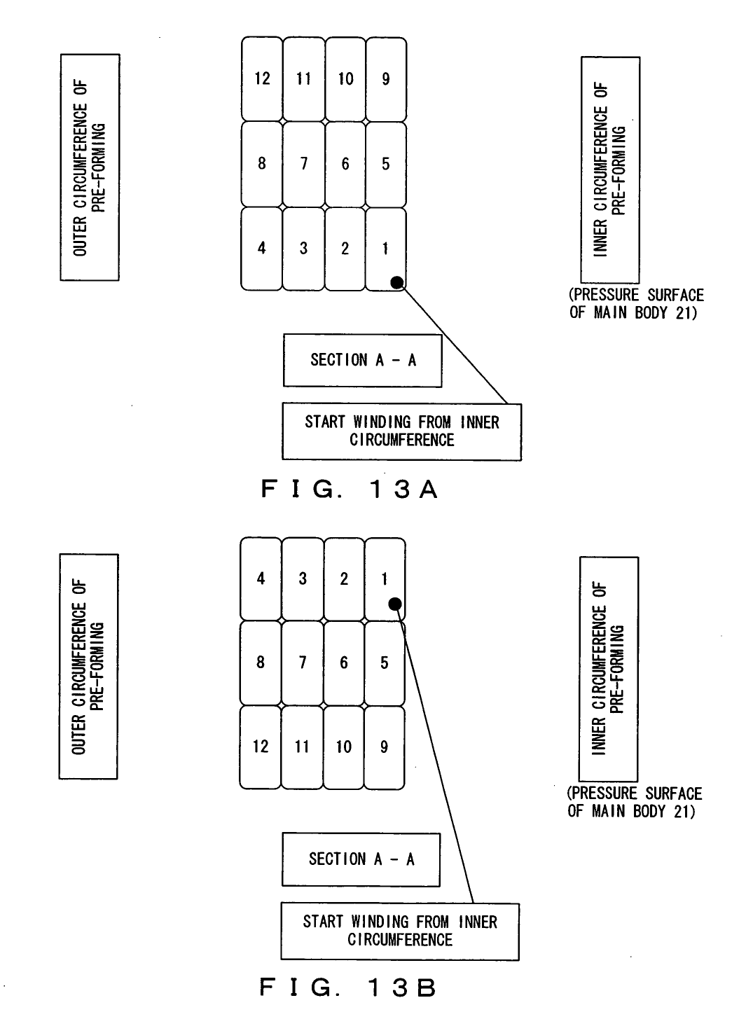

FIGS. 13A and 13B show the winding order of a flat conductor wire according to the embodiment 4. Note that while the cross-section shape of the slot of a coil stator core is assumed to be a “rectangle” in the embodiment 4 as in the embodiment 2, the basic process for winding the wire is the same as in the embodiment 3, hence omitted herein. It shall be noted that the same overall benefit is gained in the embodiment 4 as in the embodiment 3.

The coil 30 formed by using the coil pre-forming tool 20, and having been configured as shown in FIG. 6, is inserted into the corresponding slots of a stator core 10 as shown in FIGS. 7A through 7C. Here, one of the coils 30 in this embodiment corresponds to any one of the coils for the three phases. In other words, three of the coils 30 are required to be installed in the stator core 10 for configuring the stator according to the present embodiment.

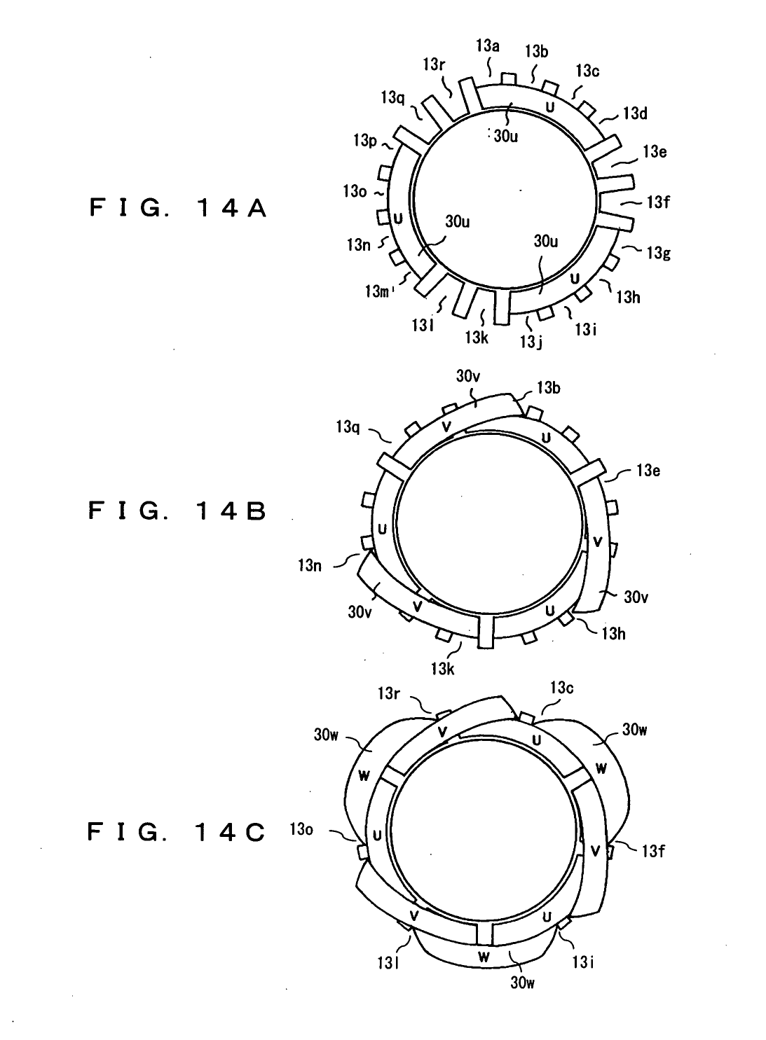

FIGS. 14A through 14C describe an insertion process for coils into the corresponding slots of a stator core, where FIGS. 14A through 14C show the top views of the stator core and the coils. The stator core has 18 slots 13a through 13r. Here assumes that three coils, i.e., a coil 30U for U-phase, a coil 30V for V-phase and a coil 30W for W-phase, are inserted into the corresponding slots 13.

First, each of the straight portions of the U-phase coil 30U is inserted into the corresponding slots 13a, 13d, 13g, 13j, 13m and 13p, as shown in FIG. 14A. In this instance, the convex curved portions and the concave curved portions of the U-phase coil 30U are arranged so that each thereof crosses over between corresponding two slots into which the straight portions of the U-phase coil 30U are inserted. Specifically, it is as described before, referring to FIGS. 7A through 7C. Note that the cross-over portions of the U-phase coil 30U, i.e., the convex and concave curved portions thereof, are placed to be biased toward the center of the stator core as much as possible in order to avoid interference with the V-phase coil 30V and the W-phase coil 30W which will be inserted subsequently later.

Then, each of the straight portions of the V-phase coil 30V is inserted into the corresponding slots 13b, 13e, 13h, 13k, 13n and 13q, as shown in FIG. 14B. In this instance, each of the cross-over portions of the V-phase coil 30V is placed to be biased toward the center of the stator core as much as possible in one side of the slot and is placed in the other side thereof so as to insert into the corresponding slot from outside of the U-phase coil 30U.

Subsequently, each of the straight portions of the W-phase coil 30W is inserted into the corresponding slots 13c, 13f, 13i, 13l, 13o and 13r, as shown in FIG. 14C. In this instance, each of the cross-over portions of the W-phase coil 30W is placed so as to insert into the corresponding slots from outside of the U-phase coil 30U and the V-phase coil 30V both of which are previously installed.

As such, by the production method according to the present embodiment, installing the coils 30U, 30V and 30W in the stator core 10 obtains a distributed and wave winding coil for each phase.

Note that the cross-over portion, i.e., the convex and concave curved portions, of each of the coils 30U, 30V and 30W maybe preformed so as to be placed as described above when installing each coils in the stator core 10. Furthermore, it is desirable to place each of the coils 30U, 30V and 30W so that each cross-over portion does not contact with each other, thus eliminating a need of an insulation processing between each coil.

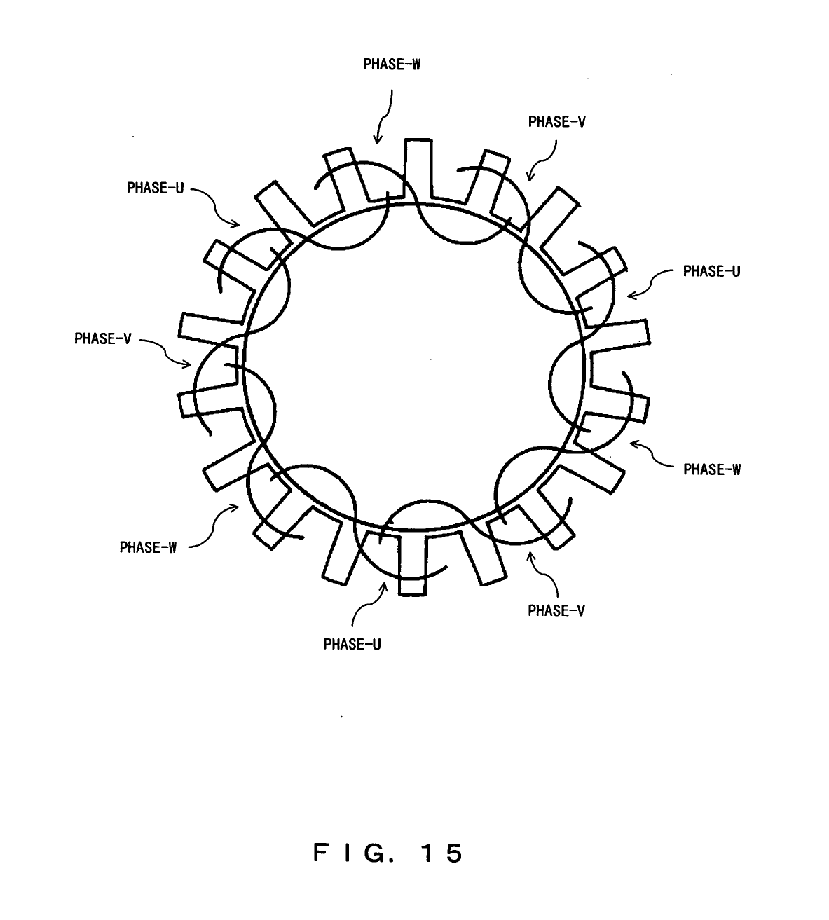

Further note, the configuration of each coil 30U through 30W is not limited as shown in FIGS. 14A through 14C, but may be in a way avoiding an interference with each other. For instance, each of the cross-over portions may be formed into an “S” shape as shown in FIG. 15. That is, the cross-over portions of each coil such as to be placed toward the center of the stator core as much as possible in one side of the slot and be placed in the other side thereof so as to insert into the corresponding slot from outside of the other coil. Note that the cross-over portion of each coil is delineated by an illustrated single line for an easy viewing in FIG. 15.

As described above, a rotating electrical unit according to the present embodiments, since the preformed coils are inserted into the corresponding slots in the stator core, while the flat conductor wires are used as a conductor wire constituting the coil, the efficiency of the rotating electrical unit is improved as well as the coil winding process is simplified.

The coil according the present embodiment is not a segment coil as described in the patent documents 3 and 4 quoted above, it is possible to obtain a higher freedom in designing the number of turns thereof, and it requires no increase in the number of slots for applying to a rotating electrical unit in a high voltage specification.

Furthermore, since the stator is obtained by inserting the preformed coil into the corresponding slots, a resultant smaller coil end gains a compact, high efficiency rotating electrical unit.

Note that a rotating electrical unit according to the present invention is not limited to the embodiments as described above. For example, in the embodiments described above, a stator core comprises an inner ring member and an outer ring member, the present invention is not limited as such. That is, a stator core, for example, can be one having slots opening toward the center of the stator, in this case preformed coils will be inserted into the corresponding slots from inside of the stator core in a way expanding the diameter thereof. In this case, the cross-section shape of each slot is basically a “rectangle” in this application.

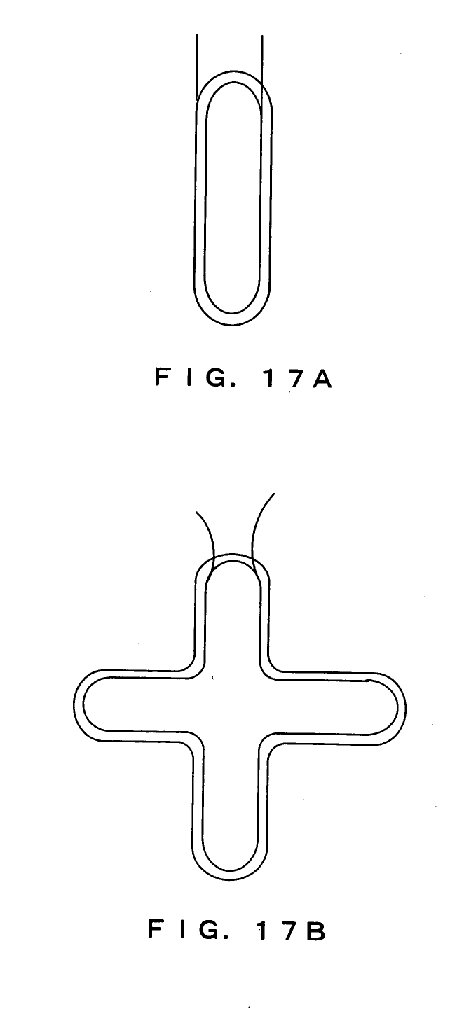

Furthermore, a rotating electrical unit is not limited to having three phases, or each phase consisting of “six” poles. For example, if the number of poles for each phase is “four”, a coil is formed by the flat conductor wires in the shape as shown in FIG. 17A. If the number of poles for each phase is “eight”, a coil is formed by the flat conductor wires in the shape as shown in FIG. 17B. Then these coils are formed as shown in FIG. 6 and then inserted into the corresponding slots in a stator core in the same process as described above for any of the above cases. Note that the former case will obtain distributed wave winding with the coils being inserted into four slots so as to cross over the plurality of slots, while the latter will obtain distributed wave winding with the coils being inserted into eight slots so as to cross over the plurality of slots.

Still furthermore, in the embodiments described above, the cross-over portions of the coil, i.e., the convex curved portions 32a through 32c, are formed in curve by the convex curved portions of the main body 21 in the coil pre-forming tool 20 as shown in FIG. 4, however there does not necessarily need to be curved. That is, for example, an optional shape having a straight portion by forming a pressure member similar to the straight line pressure member 22 is possible. Similarly, the other cross-over portions of the coil, i.e., the concave curved portions 33a through 33c, can be featured having straight portions therein as well. It shall be noted that the “curved portion of coil” in the specification of the present invention includes such alternative structures.

Yet furthermore, in the embodiments described above, although the conductor wire is wound directly around the coil pre-forming tool 20, it is not limited as such. That is, it may be such that a ring coil is formed having conductor wires aligned together as described above, and the ring coil is then formed by the coil pre-forming tool 20 as shown in FIG. 5 while the conductor wires therein maintaining the alignment at least in the portions to be inserted into the corresponding slots.

1. A production method of a rotating electrical unit, comprising:
a first process forming a coil by winding a flat conductor wire in a plurality of turns around a pre-forming member; and
a second process producing a stator by inserting the coil into three or more slots provided in a stator core of a rotating electrical unit so as to cross over the plurality of slots, wherein
the flat conductor wire is wound around the pre-forming member so that a cross-section shape of the coil is matched approximately with a cross-section shape of the slots in said first process.

2. The production method of a rotating electrical unit according to claim 1, wherein
the coil is inserted into three or more slots so as to cross over the plurality of slots and form wave winding in said second process.

3. The production method of a rotating electrical unit according to claim 1, wherein
said first process comprises
a first sub-process winding n-turns of the flat conductor wire so that the flat conductor wire is wound sequentially in n-columns lined up in the first direction while being pressed against a surface of the pre-forming member;
a second sub-process winding n-turns of the flat conductor wire so that the flat conductor wire is wound sequentially in n-columns lined up in the direction opposite to the first direction stacking outward on the flat conductor wire wound in said first sub-process; and
a third sub-process alternating said first sub-process and said second sub-process so that the flat conductor wire is wound further stacking outward on the flat conductor wire wound in said first and second sub-processes.

4. The production method of a rotating electrical unit according to claim 3, wherein
the flat conductor wire is further wound following said third sub-process so as to make the cross-section shape of the coil a trapezoid.

5. The production method of a rotating electrical unit according to claim 1, wherein
a plurality of operations for winding the flat conductor wire in a plurality of turns are performed in said first process so as to stack in the direction vertical to a surface of the pre-forming member.

6. The production method of a rotating electrical unit according to claim 5, wherein
the number of turns of winding in the plurality of operations is constant.

7. The production method of a rotating electrical unit according to claim 5, wherein
the number of turns of winding in the plurality of operations changes by one in sequence.

8. The production method of a rotating electrical unit according to claim 1, wherein
a surface of the pre-forming member is featured stepwise; and
the flat conductor wire is wound in said first process so that the number of turns of the flat conductor wire stacking in the direction vertical to each step of the surface of the pre-forming member changes by a predefined number for respective step.

9. The production method of a rotating electrical unit according to claim 1, wherein
the pre-forming member comprises a straight area and a curved area;
the coil comprises a plurality of straight portions formed by using the straight area of the pre-forming member and a curved portion formed by using the curved area of the pre-forming member; and
in said second process, each of the plurality of straight portions of the coil is inserted into the corresponding slot, and each of the curved portions of the coil is allocated so that the curved portion crosses over between the slots into which the straight portion of the coil inserted.

10. The production method of a rotating electrical unit according to claim 9, wherein
the flat conductor wires are not caused to cross with each other in the straight portion of the coil in said first process.

11. The production method of a rotating electrical unit according to claim 9, wherein
the stator core comprises a plurality of coils produced in said first process; and
each curved portion is respectively formed prior to said second process so that coils do not interfere with one another when each of the plurality of coils is installed in said stator core.

12. The production method of a rotating electrical unit according to claim 1, wherein
after said coil is treated with an insulation processing, the insulated coil is inserted into the slots in said second process.

13. A rotating electrical unit which includes a stator having a stator core installed with a coil, wherein
the coil consists of the flat conductor wire;
a cross-section shape of the coil is configured matching approximately with the cross-section shape of slots featured in the stator core; and
the stator is produced by inserting the coil into three or more slots provided in the stator core so as to cross over the plurality of slots.

14. The rotating electrical unit according to claim 13, wherein
the cross-section shape of each of the slots provided in the stator core is a trapezoid.

15. The rotating electrical unit produced by the production method according to claim 1.
